(19) United States
(12) Patent Application Publication
(10) Pub. No.: US 2025/0131046 A1
(43) Pub. Date: Apr. 24, 2025

(54) DOCUMENT SEARCH METHOD FOR PROVIDING SIMILAR INFORMATION ON SIMILAR DOCUMENTS

(71) Applicant: Tanalysis Co.,Ltd., Seoul (KR)

(72) Inventor: Inkyung CHOI, Seoul (KR)

(21) Appl. No.: 18/922,787

(22) Filed: Oct. 22, 2024

(30) Foreign Application Priority Data
Oct. 23, 2023 (KR) 10-2023-0142478
Oct. 23, 2023 (KR) 10-2023-0142479
Dec. 28, 2023 (KR) 10-2023-0195362
Oct. 10, 2024 (KR) 10-2024-0137855

(51) Int. Cl. G06F 16/93; G06F 16/9038; G06F 40/30

(52) U.S. Cl. CPC G06F 16/93; G06F 16/9038; G06F 40/30; G06F 2216/11

(57) ABSTRACT

The present invention provides a document providing method for providing similar documents that disclose inventions similar to a target invention. The present invention may comprise the steps of searching for the similar documents based on at least one phrase input by a user, listing the searched similar documents, and listing from the searched similar documents cards including the at least one phrase or at least one similar phrase having a meaning similar to the at least one phrase.

### CROSS REFERENCE TO RELATED APPLICATION

The present application claims the priorities of Korean Patent Application Nos. 10-2023-0142479 (provisional application, filing date: Oct. 23, 2023), 10-2023-0142478 (provisional application, filing date: Oct. 23, 2023), 10-2023-0195362 (regular application, filing date: Dec. 28, 2023), and 10-2024-0137855 (regular application, filing date: Oct. 10, 2024), the entire contents of which is incorporated herein for all purposes by this reference.

### BACKGROUND OF THE INVENTION

### Field of the Invention

The present invention relates to a document search method for providing similar information on similar documents.

### Description of the Related Art

Existing patent search platforms have the function of providing similar prior documents based on keywords or search conditions input by a user. However, in case an amount of similar prior documents provided by the patent search platform is very large, the user is burdened with having to select the documents he/she want from a vast number of documents. There are also frequent cases where the provided documents do not match the user's search intent, which deteriorates reliability of the search results. For this reason, the user has to spend a lot of time and effort to reach the information he/she are looking for.

In order to help the user find the necessary information efficiently, more sophisticated search algorithms and user-friendly filtering functions are essential. It is necessary to reinforce the function of evaluating and classifying the relevance of prior documents so that the user can easily find related documents directly. In addition, improvement in an interface that provides search results more intuitively and clearly is also required.

### SUMMARY OF THE INVENTION

A purpose of the present invention is to provide a document search method that shows similar information on similar documents through a user-friendly interface.

A document search method of the present invention may comprise the steps of: searching for similar documents based on at least one phrase input by a user, listing the searched similar documents, and listing from the searched similar documents cards including at least one phrase or at least one similar phrase having a meaning similar to the at least one phrase.

The document search method of the present invention can provide search results to the user through a user-friendly interface. The present invention can collect and list sentences or paragraphs including phrases input by the user among similar documents. The user can easily find the similar documents desired by the user using the listed sentences or paragraphs.

### BRIEF DESCRIPTION OF THE DRAWINGS

FIG. 1 is a drawing showing a search screen according to an embodiment of the present invention.

FIG. 2A and FIG. 2B are drawings showing a search screen according to another embodiment of the present invention.

FIG. 3 is a conceptual diagram showing a relationship between a claim selected by a user and a target invention.

FIG. 4 is a drawing showing a search result screen according to an embodiment of the present invention.

FIG. 5 is a drawing showing a search result screen according to another embodiment of the present invention.

FIG. 6 is a drawing for explaining a screen showing similar documents and cards according to an embodiment of the present invention.

FIG. 7 is a drawing showing a first type layout screen according to an embodiment of the present invention.

FIG. 8 is a drawing showing a second type layout screen according to an embodiment of the present invention.

FIG. 9 is a drawing showing a third type layout screen according to an embodiment of the present invention.

FIG. 10 is a drawing showing a fourth type layout screen according to an embodiment of the present invention.

FIG. 11 is a drawing showing a claim chart screen according to an embodiment of the present invention.

FIG. 12 is a block diagram showing the element of a document search system according to an embodiment of the present invention.

FIG. 13 is a conceptual diagram showing the comparison of a target invention and a patent document according to an embodiment of the present invention.

FIG. 14A is a drawing showing the structure of a document embedding model according to an embodiment of the present invention.

FIG. 14B is a drawing showing the structure of a sentence embedding model according to an embodiment of the present invention.

FIG. 15 is a conceptual diagram showing the training process of a document embedding model according to an embodiment of the present invention.

FIG. 16 is a flowchart for a comparison of input-based patent documents according to an embodiment of the present invention.

FIG. 17 is a flowchart for a comparison of document selection-based patent documents according to an embodiment of the present invention.

FIG. 18 is a flowchart for providing information on similar documents according to an embodiment of the present invention.

FIG. 19 is a flowchart for determining the similarity of similar documents according to an embodiment of the present invention.

FIG. 20 is a block diagram showing the configuration of a document search device according to an embodiment of the present invention.

### DETAILED DESCRIPTION OF THE INVENTION

Since the present invention may make various modifications and have various embodiments, specific embodiments will be illustrated in the drawings and described in detail. However, this is not intended to limit the present invention to the specific embodiments, and it should be understood that this includes all modifications, equivalents, or substitutes included in the spirit and technical scope of the present invention.

The terms such as first and second may be used to describe various components, but the components should not be limited by these terms. The terms are used only for the purpose of distinguishing one component from another component. For example, without departing from the scope of the present invention, a first component may be referred to as a second component, and likewise, the second component may also be referred to as the first component. The term “and/or” includes a combination of a plurality of related/described items or any one of the plurality of related/described items.

In case a certain component is referred to as being “linked” or “connected” to another component, it should be understood that there may be other component between them, although the certain component may be directly linked to or connected to another component. On the other hand, in case a certain component is referred to as being “directly linked” or “directly connected” to another component, it should be understood that there are no other component between them.

The terms used in the present application are used merely to describe specific embodiments and are not intended to limit the present invention. A singular expression covers a plural expression unless the context clearly indicates otherwise. In the present application, the terms such as “comprise” or “have” are intended to specify the presence of a feature, number, step, operation, component, part, or combination thereof described in the specification, but should be understood not to preclude the presence or addition of one or more other features, numbers, steps, operations, components, parts, or combinations thereof.

In this regard, the terms such as “about” and “substantially” described throughout the specification are used in the meaning of a numerical value or a value close to the numerical value when inherent manufacture and material tolerances are presented in the meaning mentioned, and are used to prevent unscrupulous infringers from unfairly utilizing the disclosure in which accurate or absolute values are mentioned to help understanding of the present invention. The terms “step of doing˜” or “step of˜” used throughout the specification of the present invention do not mean “step for˜.”

In this specification, the term “part” includes a unit realized by hardware, a unit realized by software, and a unit realized using both of them. In addition, one unit may be realized using two or more hardware, and two or more units may be realized by one hardware.

According to an embodiment of the present disclosure, a ‘module’ or ‘part’ may be implemented as a processor and a memory. The ‘processor’ should be broadly construed to include a general-purpose processor, a central processing unit (CPU), a microprocessor, a digital signal processor (DSP), a controller, a microcontroller, a state machine, and the like. In some circumstances, the ‘processor’ may also refer to an application specific integrated circuit (ASIC), a programmable logic device (PLD), a field programmable gate array (FPGA), and the like. The ‘processor’ may also refer to a combination of processing devices such as, for example, a combination of the DSP and the microprocessor, a combination of a plurality of microprocessors, a combination of one or more microprocessors in conjunction with a DSP core, or any other combination of such configurations. Further, the ‘memory’ should be broadly construed to include any electronic component capable of storing electronic information. The ‘memory’ may also refer to various types of processor-readable media such as a random-access memory (RAM), a read-only memory (ROM), a non-volatile random-access memory (NVRAM), a programmable read-only memory (PROM), an erasable-programmable read-only memory (EPROM), an electrically erasable PROM (EEPROM), a flash memory, a magnetic or optical data storage device, a register, etc. If the processor can read information from the memory and/or write information to the memory, the memory is called to be in electronic communication with the processor. The memory integrated in the processor is in electronic communication with the processor.

In the present disclosure, the ‘system’ may include at least one of a server device and a cloud device, but is not limited thereto. For example, the system may be configured of one or more server devices. As other example, the system may be configured of one or more cloud devices. As another example, the system may be operated by configuring the server device and the cloud device together.

Some of the operations or functions described as being performed by a terminal, an apparatus, or a device in this specification may instead be performed by a server connected to the terminal, the apparatus, or the device. Likewise, some of the operations or functions described as being performed by the server may also be performed by the terminal, the apparatus, or the device connected to the server.

Unless defined otherwise, all terms used herein, including technical or scientific terms, have the same meaning as generally understood by a person who has an ordinary knowledge in the technical field to which the present invention belongs. The terms such as those generally defined in the dictionary should be interpreted as having a meaning consistent with the meaning of the context of the relevant technology, and shall not be interpreted in an ideal or overly formal sense unless defined in the present application explicitly.

Hereinafter, with reference to the attached drawings, preferred embodiments of the present invention will be described in more detail. In order to facilitate overall understanding in describing the present invention, the same reference numerals are used for the same components in the drawings, and redundant descriptions of the same components are omitted.

A document search method of the present invention can provide search results to a user through a user-friendly interface. The present invention can collect and list sentences or paragraphs containing phrases that the user is looking for among similar documents. The user can easily find the similar documents desired by the user using the listed sentences or paragraphs.

Hereinafter, the attached drawings illustrate a user interface screen displayed to the user through the document search method of the present invention. Hereinafter, for the convenience of explanation, the document search method of the present invention is expressed as providing the screen illustrated in the drawings, but the present invention is not limited thereto. The fact that the document search method of the present invention provides the screen may mean generating data for providing the screen illustrated in the drawings and transmitting the generated data to a user's device. In addition, in the following descriptions, the ‘user’ may be a person who searches for similar documents similar to a target invention through the document search method of the present invention.

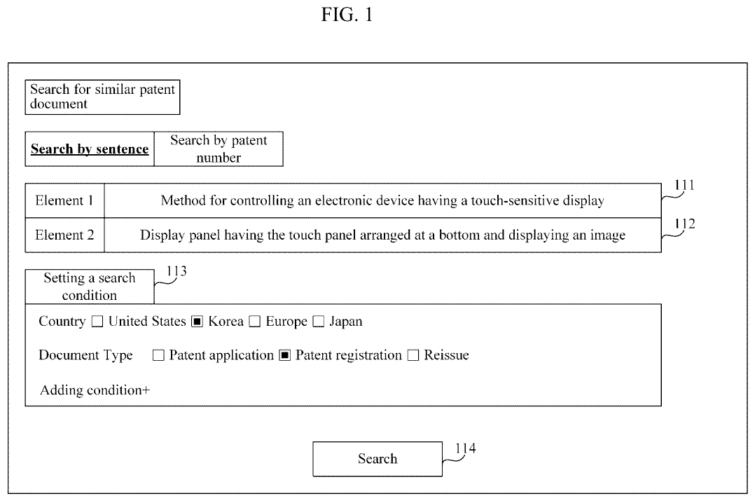

FIG. 1 is a drawing showing a search screen according to an embodiment of the present invention.

The document search method may provide a screen for receiving information on a target invention from a user. The document search method may receive information on the target invention in various ways (for example, searching by a sentence, searching by a patent number, searching by an image, uploading a document that discloses the invention). In case the user selects a search by the sentence, the document search method may display element input fields 111 and 112 for receiving information on the target invention. The user may input information in the form of phrases into the element input fields 111 and 112, respectively. The phrases input into the element input fields 111 and 112 may correspond to elements of the target invention, respectively. That is, the phrases input by the user may correspond one-to-one with the elements of the target invention, respectively. In the following descriptions, the phrase means to consist of one or more words. For example, the phrase may be in the form of a sentence in which a plurality of words are listed, or may be in the form in which the plurality of words are combined by an operator (for example, and, or, not, etc.) or one or more words are listed. The term “element” of the invention may be expressed as a configuration or component of the invention, but it is not limited thereto. The term “element” of the invention may also refer to the technical means or effects of the invention.

The document search method may display a search condition 113 for searching a document. In FIG. 1, the document search method is illustrated as displaying a country in which the document was received and a type of the document, but the present invention is not limited thereto. According to other embodiment of the present invention, the document search method may not display the search condition 113, or the search condition 113 may be configured to include various items not disclosed in the drawing.

If the user completes input of information on the target invention or/and setting of the search condition, the user may press a search button 114 at a bottom of the screen. The document search method may search for similar documents similar to the target invention when the user's input clicking the search button 114 is obtained. The name of the button is not limited thereto.

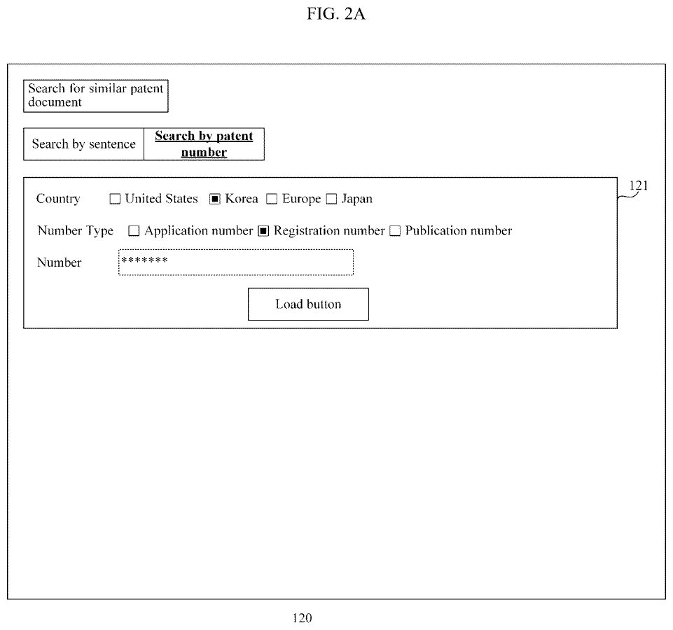

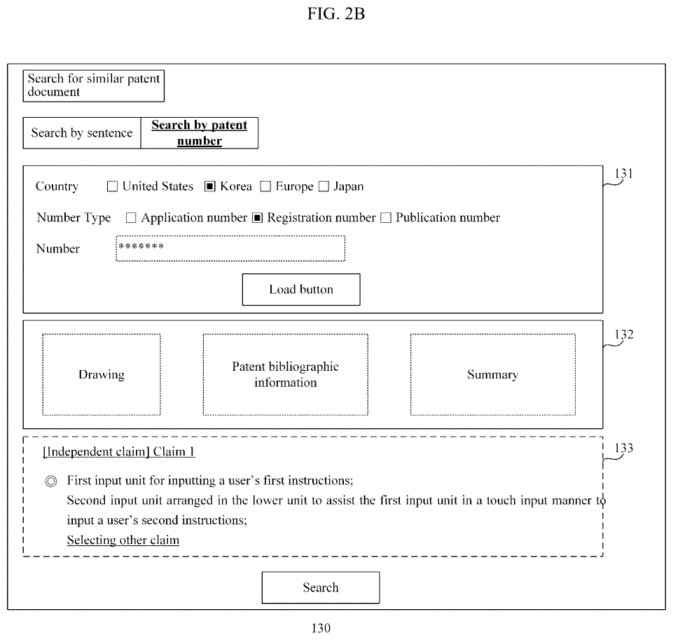

The similar documents similar to the target invention may be determined as being similar to the target invention among candidate documents based on document similarity between the target invention and the candidate documents. The document similarity may be corrected by a phrase similarity statistical value of the relevant documents. For example, the phrase similarity statistical value of a first candidate document may be calculated using a phrase similarity statistical value for a first element, the phrase similarity statistical value for a second element, . . . , the phrase similarity statistical value for a k^{th} element (k is an integer of 1 or more) and a weight for each element. The phrase similarity statistical value for the k^{th} element may be any one of a highest value, an average value, a lowest value, or an intermediate value of similarity(s) between the first similar phrase to the n^{th} similar phrase corresponding to the k^{th} element in one candidate document, or a n value (n is an integer of 1 or more) which is the number of frequency of appearance of the similar phrase, but is not limited thereto. The weight for each element may be set by a user or an administrator. Alternatively, the weight may be inversely proportional to the similarity statistical value for each element of the entire documents. For example, since a universal element has a high similarity statistical value for the corresponding elements, a low weight may be applied to the corresponding similarity. FIG. 2A and FIG. 2B are drawings showing a search screen according to another embodiment of the present invention.

The document search method may provide a screen for receiving information on a target invention from a user. The document search method may use the method described with reference to FIG. 1 (for example, the method for searching by a sentence) as well as a method for receiving information on a patent document. The user may select a search by a sentence or a search by a patent number to input information on the target invention. If the user selects a search by the patent number, the document search method may provide the user with a screen 120. The screen 120 may display a patent search area 121. The user may input information on the patent document that discloses the target invention into the patent search area 121. Although FIG. 2A and FIG. 2B illustrate that the document search method displays a country, a number type, and a number in the patent search area 121, the present invention is not limited thereto. The document search method may provide the patent search area 121 so that the user may input information on the patent document in various ways. After inputting information on the patent document, the user may click a load button.

Although the name of the button is not limited thereto, if the user clicks the load button, the document search method may provide a screen 130. The screen 130 may provide a patent search area 131, a content area 132 showing contents of the patent document searched by the user, and a claim area 133 showing claims of the patent document searched by the user. FIG. 2A and FIG. 2B illustrate that the content area 132 displays a drawing, a bibliographic information, and a summary of the patent document searched by the user, but the present invention is not limited thereto. The claim area 133 may display a claim selected by the user among claims of the patent document searched by the user. The user may select any claim desired by the user among the claims of the patent document by clicking “Selecting other claim” in the claim area 133. If the user selects a claim that cites another claim, it can be considered that information on the cited claim (appointed claim) is also selected.

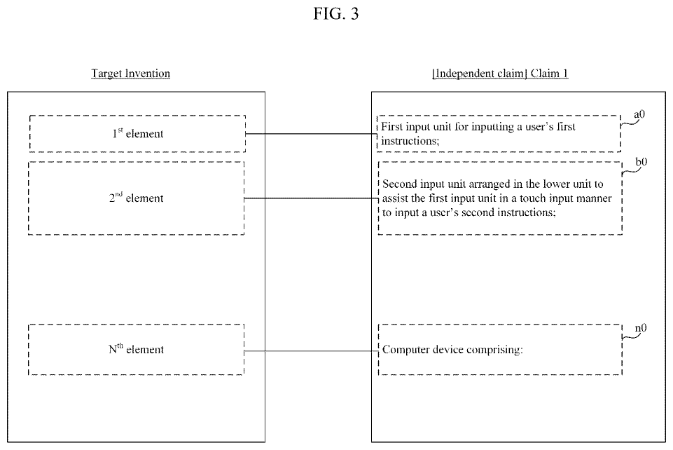

The document search method may recognize claims selected by the user as the target invention. The document search method may divide the claims selected by the user into a plurality of phrases. The plurality of phrases constituting the claims may correspond to elements of the target invention, respectively. That is, if information on the target invention input by the user is information on a patent document, the elements of the target invention may be expressed by one of the claims of the patent document or may be corrected from them by the user. This content is described in detail with reference to FIG. 3.

If the user completes input of information on the patent document, the user can press a search button. The document search method can search for similar documents similar to the target invention when input of the user who clicked the search button is obtained.

FIG. 3 is a conceptual diagram showing a relationship between a claim selected by a user and a target invention. For the convenience of explanation, FIG. 2A and FIG. 2B are referred to together.

As described with reference to FIG. 2A and FIG. 2B, in case information on the target invention input by the user is information on a patent document, the document search method may recognize claims selected by the user as the target invention. The document search method may divide the claims selected by the user into a plurality of phrases (a0, b0, . . . , n0). The plurality of phrases (a0, b0, . . . , n0) may correspond to elements of the target invention, respectively. That is, the plurality of phrases (a0, b0, . . . , n0) constituting the selected claims may correspond one-to-one with the elements of the target invention, respectively. The plurality of phrases (a0, b0, . . . , n0) may contain one or more sub-phrases. The sub-phrases may have the same elements as those of the phrases described by this specification. The phrase means to consist of one or more words. For example, the phrase may be in the form of a sentence in which a plurality of words are listed, or may be in the form in which the plurality of words are combined by an operator (for example, and, or, not, etc.) or one or more words are listed.

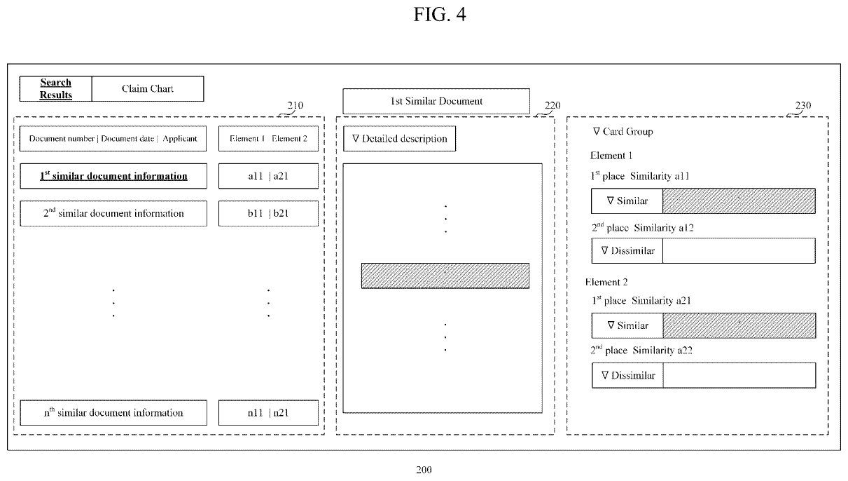

FIG. 4 is a drawing showing a search result screen according to an embodiment of the present invention.

The document search method may provide a search result screen 200 displaying search results for similar documents similar to a target invention. The search result screen 200 may include a document area 210, a matching area 220, and a phrase area 230. However, the present invention may not include some of the areas 210 to 230 shown in the search result screen 200 and may additionally include unshown areas, without being limited thereto.

The document search method may display in the document area 210 a similar document list, similarity between the target invention and the similar documents, and similarity between elements of the target invention and phrases included in the similar documents. The similarity may indicate a highest value, an average value, a lowest value, or an intermediate value among the similarities between the element for each element and each of the phrases, or may mean the number of frequencies of appearance of the similar phrases.

The document search method may search for similar documents disclosing similar inventions similar to the target invention in a database. The document search method may designate as the similar documents determined to be similar to the target invention among candidate documents based on document similarity between the target invention and the candidate documents stored in the database. The similar documents may be documents whose document similarity with the target invention is greater than or equal to a threshold document similarity. For example, the threshold document similarity may be a value predesignated by a user or an administrator. As another example, the threshold document similarity may be an average value of similarity between the candidate documents and the target invention. In this specification, the similarity between the target invention and the candidate documents may mean similarity between the target document and the candidate documents. The target document may be in the form of a document generated based on phrases input by the user or patent documents input by the user.

The document similarity between the target invention and the candidate documents may be calculated based on at least one of an average value of the phrase similarity of at least one phrase included in the candidate documents, a maximum value of the phrase similarity, a maximum value of the number of frequency of the at least one phrase, an average value of the number of frequency, and a minimum value of the number of frequency.

The document search method may generate a similar document list regarding the similar documents. The similar document list may include information on the similar documents. For example, the information on the similar documents may include a document number (application number, publication number, registration number, etc.), a document date (application date, publication date, registration date, etc.), and information on an applicant.

The document search method may generate document similarity information between the similar documents and the target invention. The document search method may display on the search result screen 200 the document similarity information between the similar documents and the target invention adjacent to the similar document list.

Further, the document search method may generate phrase similarity information between phrases of the similar documents and elements of the target invention. The document search method may display on the search result screen 200 information on similarity between the similar phrases included in the similar documents and the elements of the target invention adjacent to the similar document list. The phrase similarity information may be corrected based on a document similarity value between the target invention and the candidate documents. The similar phrase may be a phrase whose phrase similarity between the elements of the target invention among the phrases contained in the similar documents is greater than or equal to a threshold phrase similarity. In the following descriptions, the k^{th} similar phrases may be phrases whose phrase similarity with the k^{th} element is greater than or equal to the threshold phrase similarity among phrases of the similar documents. The n^{th}-k similar phrase may be a phrase whose phrase similarity with the k^{th} element is greater than or equal to the threshold phrase similarity among phrases of the n^{th} similar document. n and k are natural numbers. The threshold phrase similarity may be a value predesignated by a user or an administrator. In addition, the threshold phrase similarity may be an average value of similarity between phrases included in the similar documents and elements of the target invention.

The document search method may generate k^{th} phrase similarity information and/or n^{th}-k phrase similarity information. The k^{th} phrase similarity information and the n^{th}-k phrase similarity information mean similarity information on the k^{th} similar phrase and the n^{th}-k similar phrase, respectively. For example, the n^{th}-k phrase similarity information may be a highest value among similarities of the n^{th}-k similar phrases, the number of the n^{th}-k phrases, etc. For example, the ‘all’ shown in FIG. 4 corresponds to the 1^{st}-1 phrase similarity information. As a concrete example, the ‘all’ may be an integer between 1 and 99, which can be displayed as a numerical value expressing similarity. The phrase similarity information may be displayed adjacent to user labeling information. The labeling information is information on the relationship between the element and phrases or similar phrases included in the similar documents. The labeling information may be, for example, manually designated by a user or automatically designated by inference from an algorithm or an artificial intelligence model. The labeling information may have continuous values or discrete values. The discrete values may have, for example, at least one of similar value, related value, dissimilar value, and undesignated value.

The document search method may comprise a step of searching for the similar documents, based on the 1^{st} phrase to the m^{th} phrase in the form of sentences listing a plurality of words input by the user (wherein m is an integer of 1 or more) and the nth phrase to the k^{th} phrase in the form of a word or a plurality of words combined by an operator (wherein n and k are integers of 1 or more). In this case, the searched similar documents may be documents that include the n^{th} phrase to the k^{th} phrase while including the 1^{st} similar phrase to the m^{th} similar phrase having the meaning similar to the 1^{st} phrase to the m^{th} phrase, respectively. For example, among the documents including the 1^{st} similar phrase to the m^{th} similar phrase having the meanings similar to each of the 1^{st} phrase to the m^{th} phrase input by the user, the documents that include the n^{th} phrase to the k^{th} phrase as they are may be provided.

The document search method may display in a phrase area 230 information on similar phrases included in similar documents selected by the user. The user may select one of the similar documents displayed in the document area 210. An initial screen of the search result may display information on similar phrases included in the first similar document. The first similar document means a similar document first displayed in the document area 210.

FIG. 4 shows an initial screen of the search results or a search result screen 200 when the first similar document is selected by the user. Referring to FIG. 4, the phrase area 230 displays information on the similar phrases 1^{st}-1, 1^{st}-2, . . . , 1^{st}-m, . . . , k^{th}-1, k^{th}-2, . . . , k^{th}-m. k is the number of elements included in the target invention. For convenience of explanation, m is assumed to be 2. The document search method may list similar phrases included in the first similar document in the phrase area 230 by dividing them into the corresponding elements. That is, the document search method may list the 1^{st}-1 similar phrases sequentially and then list the 1^{st}-2 similar phrases sequentially.

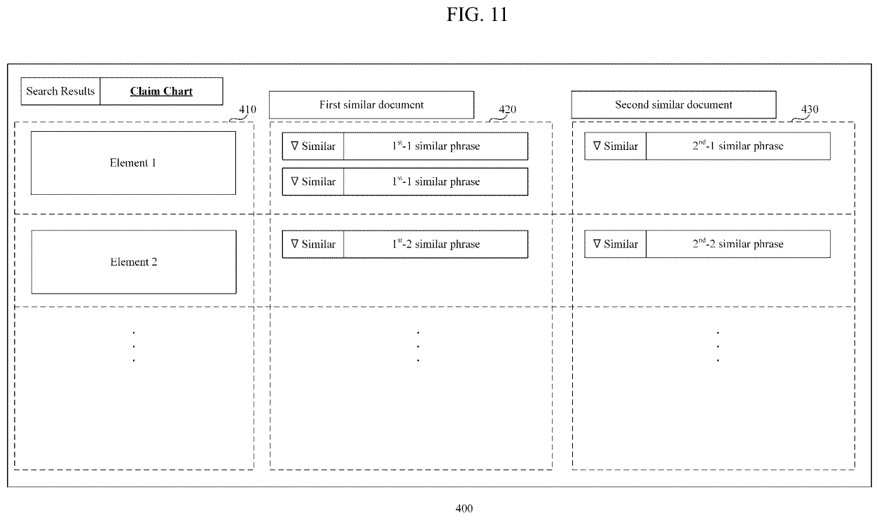

The document search method may display similar selection items adjacent to the similar phrases displayed in the phrase area 230 so that the user can finally select whether the similar phrases are similar or not. The similar selection items may consist of similar, related, and dissimilar. The user may select one of the similar selection items to select final similarity of cards. This is described in detail with reference to FIG. 11.

The user may select one of the similar phrases displayed in the phrase area 230. The document search method may display a portion that discloses the selected similar phrases among the similar documents in the matching area 220. The document search method may display in the matching area 220 not only the similar phrases but also the contents before and after the portion including the similar phrases in the similar documents. If the user clicks the selected similar phrase once more, or mouses over it, the document search method may display in the matching area 220 the next portion including the similar phrases in the similar documents. The document search method may search whether there is a portion including the similar phrases in the entire similar documents (bibliographic information, detailed description, claims, drawings).

The document area 210, the matching area 220, and the phrase area 230 may be listed in a first direction. The sub-groups included in each of the document area 210 and the phrase area 230 may be listed in a second direction. The sub-groups in the document area 210 may be information on each of the similar documents. The sub-groups in the phrase area 230 may be similar phrases divided by each of similar elements. The first direction and the second direction may be perpendicular to each other. For example, if the first direction is a horizontal direction, the second direction may be a vertical direction.

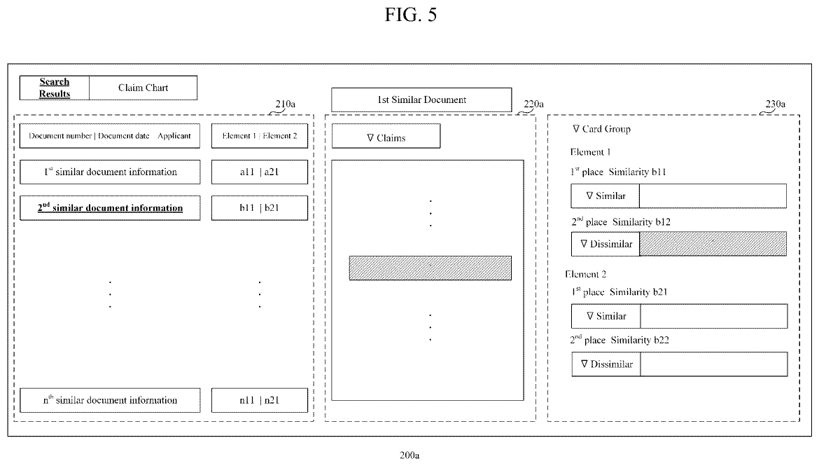

FIG. 5 is a drawing showing a search result screen according to another embodiment of the present invention. For convenience of explanation, FIG. 4 is referred to together.

FIG. 5 shows a search result screen 200a when a second similar document information is selected by a user in the document area 210 shown in FIG. 4. Referring to FIG. 5, a phrase area 230a displays information on the 2^{nd}-1 and 2^{nd}-2 similar phrases. Since the document area 210a, the matching area 220a, and the phrase area 230a are substantially the same as the document area 210, the matching area 220, and the phrase area 230, any duplicate description will be omitted below.

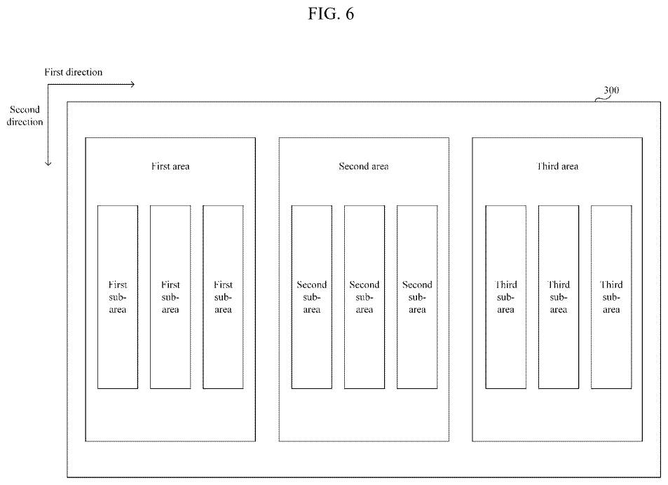

FIG. 6 is a drawing for explaining a screen showing similar documents and cards according to an embodiment of the present invention.

A card mode screen 300 such as FIG. 6 includes areas. The card mode screen 300 includes three areas, but the present invention is not limited thereto. The areas may be arranged in a first direction. Each area may include one or more sub-areas. The one or more sub-areas may be arranged in the first direction within each area. Lists (concretely, cards) displayed in each of the sub-area may be listed in a second direction. The first direction and the second direction may be perpendicular to each other.

Each of the areas may display one of a similar document list, similar document information, and first to fourth type layout screens. The sub-areas may display the content displayed in the areas more concretely. For example, each of the sub-areas in the area displaying similar document information may display one of bibliographic information, detailed description, claims, and drawings of similar documents. Specifically, the sub-areas displaying bibliographic information may display at least one of legal status of the relevant document (e.g., publication, registration, etc.), a document type, application number, application date, publication number, publication date, international publication number, international publication date, priority information, first priority date, an applicant, an inventor, a current right holder, abstract, and technical classification (e.g., IPC, CPC, etc.). The sub-areas displaying the claims may display only independent claims or both the independent claims and dependent claims according to the user's selection.

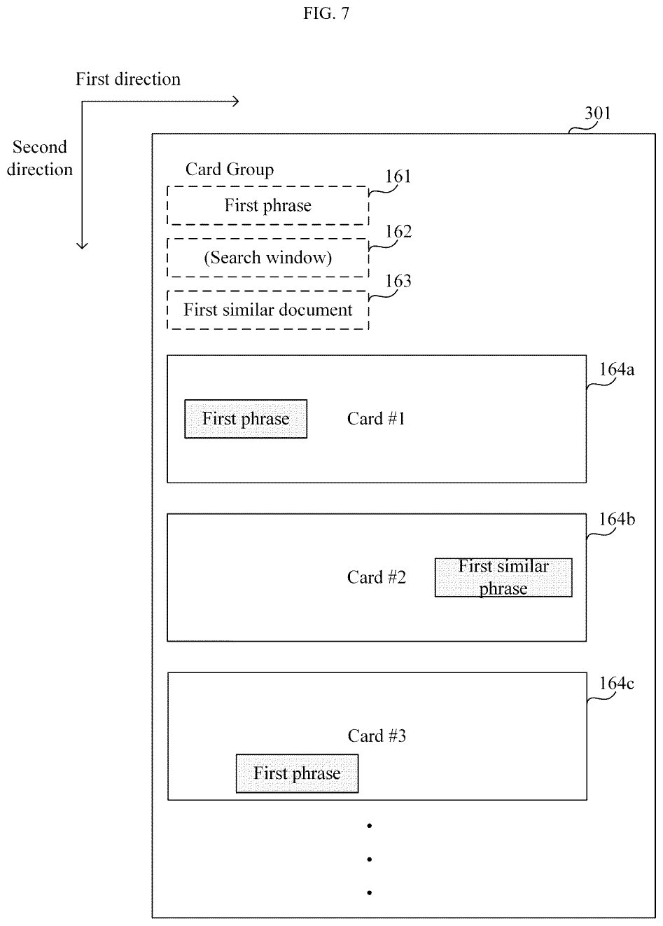

FIG. 7 is a drawing showing a first type layout screen according to an embodiment of the present invention. For convenience of explanation, FIG. 6 is referred to together.

The first type layout screen 301 is used to display a card corresponding to one element for the selected similar documents. When the area illustrated in FIG. 6 represents the first type layout screen, each sub-area included in the area may display cards corresponding to different elements for the selected one similar document.

The card mode screen 300 may consist of various combinations of similar document information and the first type layout screen 301. For example, a first area may display information on the selected similar documents, and a second area may display the first type layout screen for the selected similar documents. In this case, each sub-area included in the first area may display one of bibliographic information, detailed description, claims, and drawings for the selected similar documents, and each sub-area included in the second area may display cards corresponding to different elements for the selected similar documents. As another example, each of a plurality of areas may display the first type layout screen 301 for different similar documents.

When searching for the similar documents, one or more phrases corresponding to each of one or more elements may be input. The first type layout screen 301 may display first cards 164a, 164b and 164c including one or more first phrases corresponding to one element or first similar phrases similar to the one or more first phrases, among the selected similar documents. The first cards 164a, 164b and 164c may be listed in a second direction perpendicular to a first direction. A plurality of cards 164a, 164b and 164c may be listed according to similarity with the first phrases.

Herein, the card means a part of similar documents including at least one phrase input by a user or a similar phrase having a meaning similar to the at least one phrase. Referring to FIG. 3, the document search method may divide claims selected by the user into a plurality of phrases (a0, b0, . . . , n0). The plurality of phrases (a0, b0, . . . , n0) may correspond to elements of the target invention, respectively. The document search method may select one or more phrases corresponding to one element among one or more phrases input by the user. The document search method may display cards including the selected phrases and similar phrases similar to the selected phrases. The similar phrase may be a phrase that has a form different from but the same meaning as the at least one phrase input by the user, may be a phrase having particles omitted or added, or may be a phrase having the same root through natural language processing.

Referring to FIG. 7, the first type layout screen 301 includes a selection phrase area 161, a search window 162, document information 163, and a plurality of cards 164a, 164b and 164c. The selection phrase area 161 may display a phrase corresponding to an element selected by the user among phrases input when searching for the similar documents. The search window 162 is an area for inputting a phrase to be searched for the plurality of cards 164a, 164b and 164c. The user may input a phrase through the search window 162. In this case, cards including the phrase input through the search window 162 may be displayed.

The document information area 163 is an area for displaying information on the selected similar documents. The document search method may display brief information on the similar documents (for example, at least one of title of the invention, application number, publication number, and registration number) through the document information area 163.

In this case, according to the user's input, the document search method may set a scope from which the card is extracted. For example, the scope from which the card is extracted may be any one or more of the title, abstract, independent claim, dependent claim, entire claim, and description of the invention, or may be a combination thereof. The scope from which the card is extracted may be set differently for every phrases, respectively. The set scope may be displayed together with the selected phrases in the selection phrase area 161.

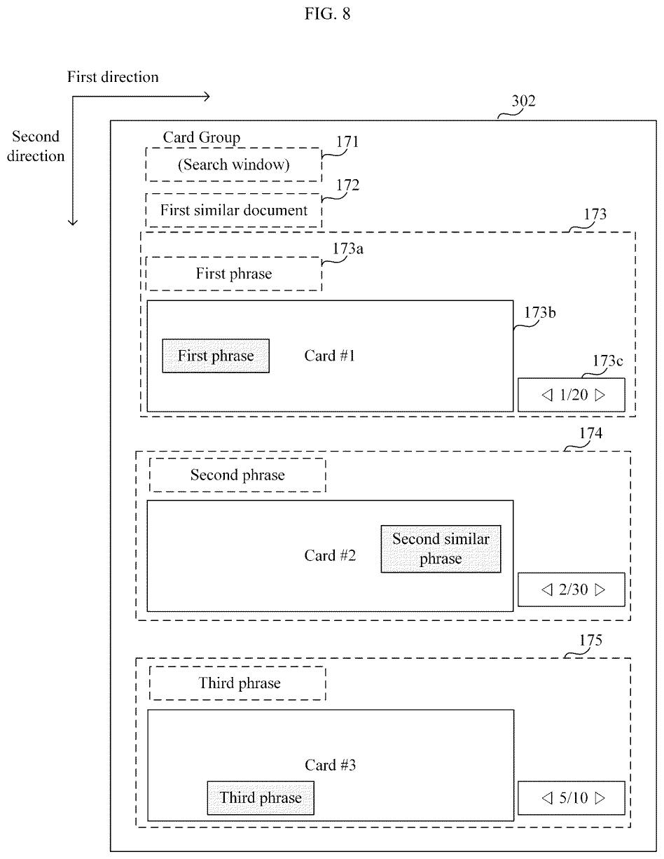

FIG. 8 is a drawing showing a second type layout screen according to an embodiment of the present invention.

The second type layout screen 302 is used to display cards corresponding to a plurality of elements for selected similar documents. The card mode screen 300 may consist of various combinations of similar document information, the first type layout screen 301, and the second type layout screen 302. For example, a first area may display information on the selected similar documents, a second area may display the first type layout screen 301 for the selected similar documents, and a third area may display the second type layout screen 302 for the selected similar documents. In this case, the second area may display cards for the remaining elements that are not displayed in the first area. As another example, when only the second type layout screen 302 appears on the card mode screen 300 without the first type layout screen 301, the second type layout screen 302 may display cards for all the elements.

The second type layout screen 302 may display element areas 173, 174 and 175 corresponding to each of the plurality of elements. The element areas 173, 174 and 175 may be listed in a second direction. Each of the element areas 173, 174 and 175 may display one or more cards of the groups including one or more phrases corresponding to the relevant elements and similar phrases similar to the one or more phrases.

The element area 173 includes a selection phrase area 173a, a card 173b, and a page cursor 173c. The element area 173 may be an area for indicating the cards included in a first card group corresponding to a first element. The element area 173 may display the card 173b corresponding to the first element. The selection phrase area 173a and the card 173b are substantially the same as the selection phrase area 161 and the card 164a described with reference to FIG. 7. The second type layout screen 302 may display another card included in the first card group instead of the card (173b) depending on a user's operation (e.g., selecting the page cursor 173c, touching the screen, scrolling, etc.). That is, depending on the user's operation, the card displayed in the element area 173 may be replaced with another card. The number of cards displayed in the element area 173 simultaneously is not limited to one, and the element area (173) may display one or more cards simultaneously. Since the element areas 173, 174 and 175 have substantially the same element, the description of the remaining element areas 174 and 175 is omitted.

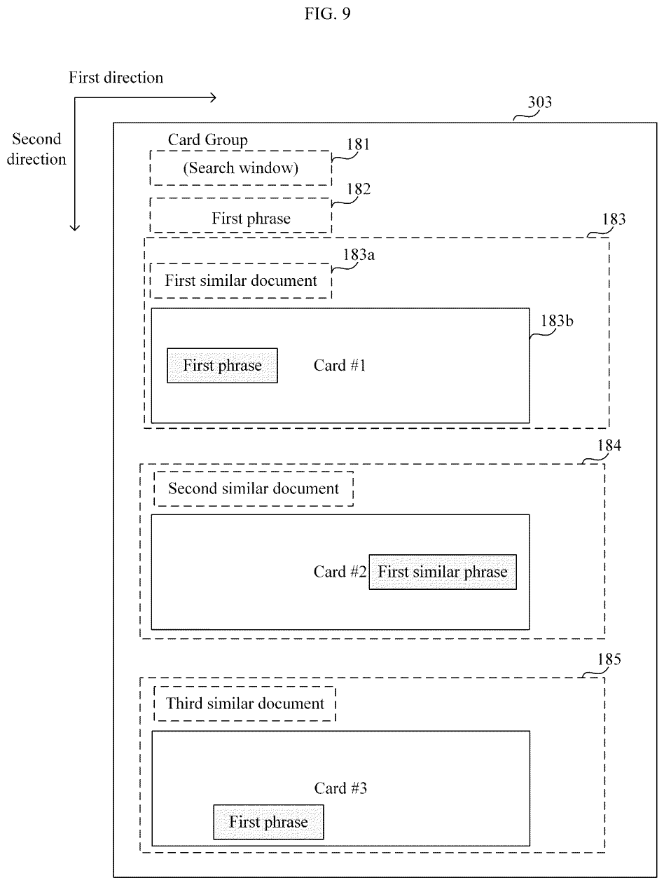

FIG. 9 is a drawing showing a third type layout screen according to an embodiment of the present invention.

The third type layout screen 303 is used to display a card corresponding to one element for a plurality of similar documents. In case the area shown in FIG. 6 represents the third type layout screen 303, each of sub-areas included in the area may display a card corresponding to a different element for the plurality of similar documents.

Similar to what was described with reference to FIG. 8, the card mode screen 300 may consist of various combinations of a similar document list, similar document information, a first type layout screen 301, a second type layout screen 302, and a third type layout screen 303. For example, if a first area represents the third type layout screen 303, a second area may represent the first type layout screen (301). In this case, the first area may display a card corresponding to one element for the entire similar documents. If the first area includes a plurality of sub-areas, each sub-area may display cards corresponding to different elements. The second area may display a card corresponding to one element of a selected similar document among the entire similar documents. As another example, if the first area represents the third type layout screen 303, the second area may display the similar document list. In addition, the first area may represent the third type layout screen 303, and the remaining areas may be configured of the combinations described with reference to FIGS. 6 to 8.

The third type layout screen 303 may display document areas 183, 184 and 185 corresponding to a plurality of documents, respectively. The document areas 183, 184 and 185 may be listed in a second direction. Each of the document areas 183, 184 and 185 may display one card including one or more phrases corresponding to the relevant elements and similar phrases similar to the one or more phrases. The documents indicated by each of the document areas 183, 184 and 185 may be the same. The document areas 183, 184 and 185 may be listed according to similarity between each card included in the document areas 183, 184 and 185 and the first phrase.

The document area 183 may display a document information area 183a and a card 183b. Since the document areas 183, 184 and 185 have substantially the same element, the description of the remaining document areas 184 and 185 is omitted.

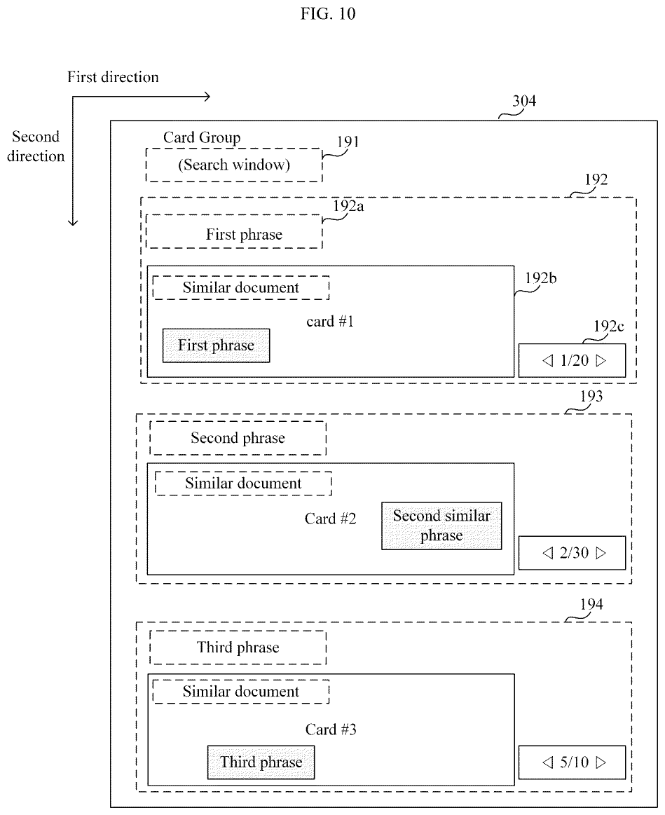

FIG. 10 is a drawing showing a fourth type layout screen according to an embodiment of the present invention.

The fourth type layout screen 304 is used to display cards corresponding to a plurality of elements for a plurality of similar documents. The fourth type layout screen 304 may display element areas 192, 193 and 194 corresponding to the plurality of elements, respectively. The element areas 192, 193 and 194 may be listed in a second direction. Each of the element areas 192, 193 and 194 may display one or more cards of card groups including one or more phrases corresponding to the relevant elements for the plurality similar documents and similar phrases similar to the one or more phrases.

The element area 192 includes a selection phrase area 192a, a card 192b, and a page cursor 192c. In this case, the card 192b may also display information on the similar documents including the card. The element area 192 may be an area for displaying cards included in a first card group corresponding to a first element. The element area 192 may display the card 192b corresponding to the first element. The cards displayed in the element area 192 may not be cards included in one similar document, but may be cards included in a plurality of similar documents. The fourth type layout screen 304 may display another card included in the first card group instead of the card 192b depending on a user's operation (e.g., selecting the page cursor 192c, touching the screen, scrolling, etc.). That is, depending on the user's operation, the card displayed in the element area 192 may be replaced with another card. The number of cards displayed in the element area 192 simultaneously is not limited to one, and the element area 192 may display one or more cards simultaneously. Since the element areas 192, 193 and 194 have substantially the same element, the description of the remaining element areas 193 and 194 is omitted.

Similar to what was described with reference to FIG. 9, the card mode screen 300 may consist of various combinations of a similar document list, similar document information, a first type layout screen 301, a second type layout screen 302, a third type layout screen 303, and a fourth type layout screen 304.

For example, if a first area represents the fourth type layout screen 304, a second area may represent the first type layout screen 301. In this case, the first area may display a card corresponding to one element for the entire similar documents. If the first area includes a plurality of sub-areas, each of the sub-areas may display cards corresponding to different elements. The second area may display a card corresponding to one element for the selected similar document among the entire similar documents. As another example, if the first area represents the fourth type layout screen 304, the second area may display the similar document list. In addition, the first area may represent the fourth type layout screen 304, and the remaining areas may configured of combinations described with reference to FIGS. 6 to 9.

In the areas and sub-areas described with reference to FIGS. 6 to 10, the similar documents and the cards may be listed in order of similarity with a target invention and a target phrase. The similar documents may be listed basically in order of similarity with the searched invention. When a user selects a specific element, the similar documents and/or the cards may be listed in order of similarity with the phrase corresponding to the element. The similarity of the cards may indicate a highest value, an average value, a lowest value, or an intermediate value among the similarities between the element for each element and each of the phrases, or may mean the number of frequencies of appearance of the similar phrases. The similarity of the similar documents may be determined as a value that reflects a weight of the statistical value of the similarity of the cards included in each of the similar documents (for example, the highest value, the average value, the lowest value, or the intermediate value). In this case, different weights may be applied to the similarity of the cards corresponding to each element for each of the elements. The weight may be inversely proportional to the statistical value of the similarity for each element for the entire documents. For example, since a universal element may have a high statistical value of the similarity to the corresponding element, a low weight may be applied to the corresponding similarity.

FIG. 11 is a drawing showing a claim chart screen according to an embodiment of the invention.

Referring to FIG. 11, if a user selects a claim chart, the document search method may display a claim chart screen 400. The document search method may display an element area 410 and similar phrase areas for each document 420 and 430 on the claim chart screen 400. The similar phrase areas for each document 420 and 430 may include drawings or images selected by the user, or sequence lists. The similar phrase areas for each document 420 and 430 may include phrases designated by the user as being similar to the target phrase or texts directly input by the user. It may also include information that can identify the user who has selected, designated, or input. In addition, if the user selects report generation, a report (e.g., a document, a table, a drawing) in which the element area 410 and the similar phrase areas for each document 420 and 430 are arranged as shown in FIG. 9 may be generated.

In this case, the similar phrase areas for each document 420 and 430 may be displayed so as to be distinguished by each corresponding element (for example, element 1, element 2, etc. included in the element area 410). Specifically, each of the similar phrase areas for each document 420 and 430 may display at least one card corresponding to the element 1 and at least one card corresponding to the element 2 so as to be distinguished from each other. That is, the similar phrase areas for each document 420 and 430 corresponding to the element 1 may be listed in the same row as each other, and may be listed in a different row from the similar phrase areas for each document 420 and 430 corresponding to the element 2. In addition, first cards included in the similar phrase area 420 may be listed in the same column as each other, and may be listed in a different column from second cards included in the similar phrase area 430.

The element area 410 and the similar phrase areas for each document 420 and 430 may be listed in a first direction. Sub-groups included in each of the element area 410 and the similar phrase areas for each document 420 and 430 may be listed in a second direction. The first direction and the second direction may be perpendicular to each other. For example, if the first direction is a horizontal direction, the second direction may be a vertical direction.

The document search method may display elements of the target invention on the element area 410. The elements of the target invention may be listed on the element area 410 in the second direction.

According to an embodiment of the present invention, a first similar document and a second similar document included in the claim chart screen 400 may be similar documents stored by the user on the search result screen 200 as shown in FIG. 4. That is, the document search method may store at least one similar document on the search result screen 200 according to a user's request, and may display at least one similar document (e.g., the first similar document, the second similar document) stored according to selection of the claim chart.

According to an embodiment of the present invention, cards displayed on the similar phrase areas for each document 420 and 430 may be similar phrases selected as being similar by the user among the similar selection items on the search result screen 200 as shown in FIG. 4. The cards displayed on the first similar document-similar phrase area 420 may be phrases included in the first similar document among the cards finally determined as similar. The similar phrases displayed on the second similar document-similar phrase area 430 may be cards included in the first similar document among the cards finally determined as similar. The cards finally determined as similar may be selected by the user, or may be cards having high similarity.

The similar phrases displayed on the similar phrase areas for each document 420 and 430 may be divided by each similar element and listed in the second direction. That is, the document search method may label at least one similar phrase on the search result screen 200 according to the user's instructions, and may display at least one labeled card stored according to selection of the claim chart. Herein, the labeling may be made by allowing the user to click or select a selection item (e.g., a button, etc.) provided along with each of the cards included in the search result screen 200.

Although FIG. 11 shows only cards for each similar document, it may also further display similar drawings in addition to the cards. For example, at least one drawing in the relevant similar document may be displayed at a bottom of the cards. In this case, according to an embodiment of the present invention, only drawings selected as similar by the user may be displayed. That is, the document search method may label at least one similar drawing on the search result screen 200 according to the user's instructions, and display at least one similar drawing labeled according to selection of the claim chart.

Additionally, according to an embodiment of the present invention, the document search method may generate and provide contents of the claim chart screen 400 of FIG. 11 in a separate file format. For example, the document search method may generate and provide a separate report file (e.g., an Excel file or a Word file) including cards and drawings labeled as similar by the user in at least one similar document stored by the user, in the format of an Excel file, a Word file, etc. As a concrete example, the report file may include at least one of bibliographic information of the document, a comparison table between elements of the target invention and the similar documents, and explanation of similarities and differences between the target invention and the similar documents. The report file may be edited.

According to an embodiment of the present invention, in a document providing method for providing similar documents that disclose inventions similar to a target invention, the method is performed by at least one processor and comprises the steps of: searching for the similar documents based on at least one phrase input by a user; and listing first cards including at least one of a first phrase or a first similar phrase similar to the first phrase from one document of the searched similar documents, wherein the first phrase is a phrase corresponding to a first element among the at least one phrase input by the user.

According to an embodiment of the present invention, the method that is performed by at least one processor may provide a claim chart providing method comprising the steps of: searching for similar documents based on at least one phrase input by a user; and displaying first cards including at least one of a first phrase or a first similar phrase similar to the first phrase from the searched similar documents, wherein the first phrase is a phrase corresponding to a first element among the at least one phrase input by the user. The method may further comprise a step of displaying similarities and/or differences between the first card and the first element.

The document search method of the present invention may be a method that is performed by at least one processor, and searches a database for similar documents disclosing similar inventions similar to a target invention. The document search method of the present invention may comprise the steps of: generating a similar document list regarding similar documents determined to be similar to the target invention among candidate documents, based on document similarity between the target invention and the candidate documents, and generating first phrase similarity information on first phrases determined to be similar to a first element among the phrases, based on phrase similarity between the first element among the elements of the target invention and the phrases included in the similar documents. In this case, each of the first phrases may consist of one or more words.

The step of generating the similar document list may include adding to the similar document list similar documents among the candidate documents whose document similarity with the target invention is greater than or equal to a threshold document similarity.

The step of generating the first phrase similarity information may include generating a first phrase similarity information on the first phrases among the phrases whose phrase similarity with the first element is greater than or equal to a threshold phrase similarity.

The document search method of the present invention may further comprise a step of acquiring information on the target invention. In case information on the target invention is input in the form of a plurality of phrases, the plurality of input phrases may correspond one-to-one with the elements of the target invention.

The document search method of the present invention may further comprise a step of acquiring information on the target invention. In case information on the target invention is information on a patent document describing the target invention, the elements of the target invention may be expressed by one of the claims of the patent document.

The elements of the target invention and the phrases constituting one of the claims may correspond one-to-one.

The document search method of the present invention may further comprise a first listing step of listing a similar document list in a document area, and listing in a phrase area a 1^{st}-1 phrase belonging to a first similar document among the first phrases. The first similar document may be one of the similar documents belonging to the similar document list.

The first listing step may include listing the 1^{st}-1 phrase and the 1^{st}-2 phrase in the phrase area, wherein the 1^{st}-2 phrase is a phrase belonging to the first similar document among the second phrases determined to be similar to the second element among the elements of the target invention.

The document search method of the present invention may further comprise a second listing step of listing in the phrase area the 2^{nd}-1 phrase belonging to the second similar document among the first phrases instead of the 1^{st}-1 phrase when a user's input of selecting the second similar document from the similar document list listed in the document area is obtained.

The document search method of the present invention may further comprise a third listing step of listing in a matching area a portion including the 1^{st}-1 phrase in the first similar document when a user's input of selecting the 1^{st}-1 phrase listed in the first phrase area is obtained.

The third listing step may list similar documents included in the similar document list on the document area in a first direction, and the document area, the matching area, and the phrase area may be listed in a second direction perpendicular to the first direction.

The document search method of the present invention may further comprise a fourth listing step of rearranging similar documents so that the similar documents listed on the document area satisfy a listing criterion when a user's input for selecting the listing criterion for the similar documents is obtained.

The document search method of the present invention may further comprise a fifth listing step of filtering similar documents so that the similar documents listed on the document area satisfy a scope criterion when a user's input for selecting the scope criterion for the similar documents is obtained.

The first listing step may list similarity between the first element and the 1^{st}-1 phrase on the phrase area so that it is adjacent to the 1^{st}-1 phrase listed on the phrase area.

The first listing step may list similarity between each of the elements of the target invention and the first similar document on the document area so that it is adjacent to the first similar document listed on the document area.

The document search method of the present invention may further comprise a sixth listing step of listing on the final area one or more of final first phrases selected by the user among the first phrases.

The step of generating the similar document list may calculate each of the document similarities between the target invention and the candidate documents based on at least one of an average value of phrase similarity of at least one phrase included in each of the candidate documents, a maximum value of phrase similarity of at least one phrase, a maximum value of the number of frequency of at least one phrase, an average value of the number of frequency, and a minimum value of the number of frequency.

The document search method of the present invention may be a method that is performed by at least one processor and searches a database for similar documents describing similar inventions similar to a target invention. The document search method of the present invention may comprise the steps of: generating information on similar documents determined to be similar to the target invention among the candidate documents based on document similarity between the target invention and the candidate documents; and generating information on a table in which similar document blocks corresponding to the similar documents respectively are listed in a first direction, and final similar phrases determined to be similar to the elements of the target invention among similar phrases included in the similar documents corresponding to the similar document blocks respectively are listed in a second direction. Each of the phrases may consist of one or more words.

The document search method of the present invention may further comprise a step of listing the similar documents in a document area and listing the similar phrases in a phrase area on a search result screen.

According to the document search method of the present invention, the step of generating information on the table may further include the steps of: obtaining information on final similar phrases selected as similar by a user among the similar phrases listed in the phrase area on the search result screen, listing similar document blocks on a global claim chart screen in a first direction, and listing the final similar phrases by dividing them into each of similar elements in a second direction.

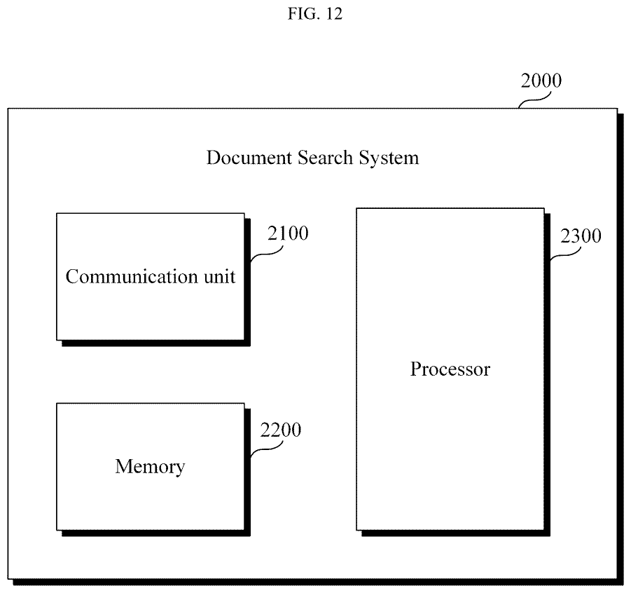

FIG. 12 is a block diagram showing the element of a document search system according to an embodiment of the present invention.

The document search system 2000 illustrated in FIG. 12 can perform the document search method described with reference to FIGS. 1 to 11. The document search system 2000 may include a communication unit 2100, a memory 2200, and a processor 2300. The document search system 2000 may be implemented as an embedded board, a smart phone, a tablet PC, a PC, a smart TV, a mobile phone, a personal digital assistant (PDA), a laptop, a vehicle, and other mobile or non-mobile computing device, but is not limited thereto.

The communication unit 2100 may include one or more components that allow the document search system 2000 to communicate with an external electronic device. The communication unit 2100 may include a short-range wireless communication unit (not shown), a mobile communication unit (not shown), or a broadcast receiving unit (not shown). The short-range wireless communication unit may include a Bluetooth communication unit, a Bluetooth low energy (BLE) communication unit, a near field communication unit, a WLAN (Wi-Fi) communication unit, a Zigbee communication unit, an infrared (IrDA, infrared Data Association) communication unit, a WFD (Wi-Fi Direct) communication unit, a UWB (Ultra Wideband) communication unit, an Ant+ communication unit, etc., but is not limited thereto. The mobile communication unit transmits and receives a wireless signal with at least one of a base station, an external terminal, and a server on a mobile communication network. Herein, the wireless signal may include various types of data according to transmission and reception of a voice call signal, a video call signal, or text/multimedia message. The broadcast receiving unit receives a broadcast signal and/or broadcast-related information from the outside through a broadcast channel. The broadcast channel may include a satellite channel or a terrestrial channel. According to an embodiment, the communication unit 2100 may not include the broadcast receiving unit. The document search system 2000 may also receive order logs for existing items, attribute information for existing items, and attribute information for new items from an external device through the communication unit 2100.

The memory 2200 may store a program for processing and controlling the processor 2300, and may also store data input to or output from the document search system 2000. In addition, the memory 2200 may store information on candidate documents searched by the document search system 2000.

The memory 2200 may include at least one type of storage medium among a flash memory type, a hard disk type, a multimedia card micro type, a card type memory (for example, an SD or XD memory, etc.), a RAM (Random-Access Memory), a SRAM (Static Random-Access Memory), a ROM (Read-Only Memory), an EEPROM (Electrically Erasable Programmable Read-Only Memory), a PROM (Programmable Read-Only Memory), a magnetic memory, a magnetic disk, and an optical disk.

The processor 2300 may typically control overall operation of the document search system 2000. The processor 2300 may perform the document search method described with reference to FIGS. 1 to 9 by executing programs stored in the memory 2200. The processor 2300 may be implemented as a CPU (Central Processing Unit), and may also be implemented as a processing device such as a GPU (Graphic Processing Unit) and an NPU (Neural Processing Unit).

The above-described contents are concrete embodiments for carrying out the present invention. The present invention will include not only the above-described embodiments, but also embodiments that may be simply designed and changed or be easily changed. In addition, the present invention will also include technologies that can be easily modified and implemented using the embodiments. Therefore, the scope of the present invention should not be limited to the above-described embodiments, but should be determined by the claims described below as well as the equivalents to the claims of the present invention.

The present invention may generate a document embedding that represents each of a target invention and patent documents by considering the structure of the target invention and the patent documents which are subjected to comparison, and may quickly obtain a similar document list based on the document embedding. The present invention may effectively compare similarity between the target invention and the patent documents by comparing sentence embeddings corresponding to the detailed contents of the target invention and the similar documents.

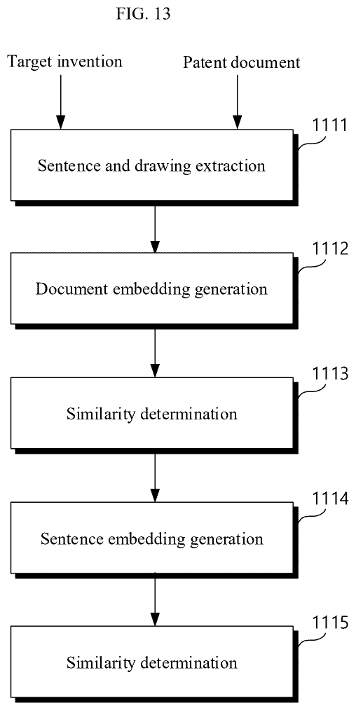

FIG. 13 is a conceptual diagram showing the comparison of a target invention and a patent document according to an embodiment of the present invention.

Referring to FIG. 13, the comparison of the target invention and the patent document according to an embodiment of the present invention is performed through sentence and drawing extraction 1111, document embedding generation 1112, similarity determination 1113, sentence embedding generation 1114, and similarity determination 1115. In the sentence and drawing extraction 1111, the document search method is configured to extract sentences and drawings to be used for comparison from each of the target invention and the patent document, and convert the sentences and drawings into data. In the sentence and drawing extraction 1111, the document search method is configured to generate document embedding based on the data of the sentences and drawings. In the similarity determination 1113, the document search method is configured to determine a primary similarity, which is the similarity of a document level of the target invention and the patent document, based on the document embedding. The document search method is configured to obtain a similar patent document list based on the primary similarity.

Also, in the sentence embedding generation 1114, the document search method is configured to extract sentences and drawings to be used for the comparison from each of the target invention and similar patent documents, and convert the sentences and drawings into data. In the similarity determination 1115, the document search method is configured to determine a secondary similarity, which is the similarity of a sentence level, based on the sentence embeddings of the target invention and the patent document. Herein, the primary similarity is used to determine whether or not it is a similar document, and the secondary similarity is used as the similarity provided to a user.

That is, the search system based on the document comparison according to the embodiment of the present invention uses a document model and/or a sentence model, and can search for similar patent documents by documenting the input words and/or sentences. Furthermore, the search result according to the present invention can be utilized to list the similar documents for each similarity by comparing the sentences of the searched patent documents with the input sentences (including words).

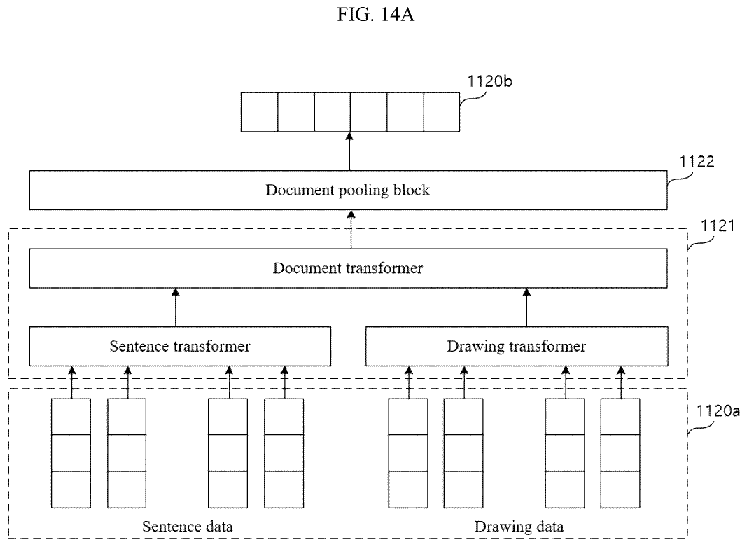

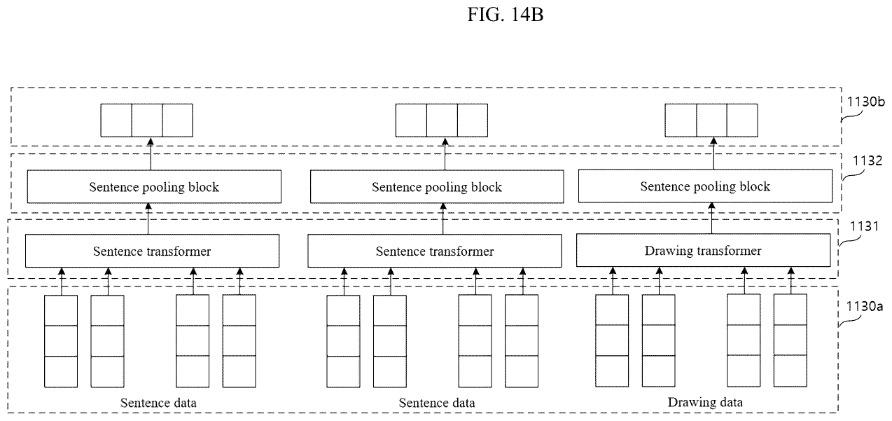

FIG. 14A is a drawing showing the structure of a document embedding model according to an embodiment of the present invention. FIG. 14A shows the structure of an artificial intelligence model that can be used to perform the document embedding generation 1112 of FIG. 13.

Referring to FIG. 14A, the document embedding model includes a sentence-document hierarchical transformer block 1121 and a document pooling block 1122.

The sentence-document hierarchical transformer block 1121 receives primary embeddings 1120a including sentence embedding and/or drawing embedding as tokens, and generates embeddings for each comparison element using transformers of a hierarchical structure. Specifically, the sentence-document hierarchical transformer block 1121 applies a sentence transformer and/or an image feature extractor for each comparison element to the input tokens, and applies a document transformer to the results to generate a secondary embedding.

In other words, the sentence-document hierarchical transformer block 1121 tracks the relationship between the tokens included in the primary embeddings for each comparison element, and generates individual embeddings converted to express context and meaning. Then, the sentence-document hierarchical transformer block 1121 combines the individual embeddings, and generates an integrated embedding for the entire new document through an encoder and a decoder for the combined embeddings.

Referring to FIG. 14A, although the document embedding model is described to receive the sentence data-based primary embeddings 1120a and apply the sentence transformer for each comparison element, the present invention is not limited thereto. The document embedding model may also receive primary embeddings formed in paragraph units and apply a paragraph transformer to the primary embeddings. That is, the primary embeddings 1120a may be generated in response to each of some sentences included in the patent documents, some paragraphs included in the patent documents, and constitutions included in the patent documents (e.g., bibliographic information, description of the invention, claims, etc.).

In this case, although not shown in FIG. 14A, a block for generating the primary embeddings may exist, wherein the block for generating the primary embeddings may be implemented as an artificial intelligence model. For example, the block for generating the primary embeddings for sentences may extract sentences from a document as technical meaning units and generate embeddings corresponding to the extracted sentences. For example, the block for generating the primary embeddings for a drawing may be used to implement a multi modal structure, and may generate embeddings that express the shape, arrangement, etc. of the constitutive elements (e.g., features, letters, numbers, etc.) that constitute a patent drawing.

In this case, the block for generating the primary embeddings may understand all languages as a single symbol by applying a byte-level tokenization technology of the patent domain. Accordingly, it is possible to grasp the same meaning without distinction of languages. In addition, in order to support data embedding of non-standard descriptions, the block for generating the primary embeddings may generate a knowledge graph based on LLM (Large Language Models) and utilize CAS (Chemical Abstracts Service), API (Application Programming Interface). Accordingly, it is possible to understand chemical formulas or DNA (Deoxyribo Nucleic Acid) sequences.

The document pooling block 1122 combines secondary embeddings and generates a document embedding 1120b by reducing the dimension. Through this, the document embedding 1120b representing the document can be obtained so as to compare the corresponding document.

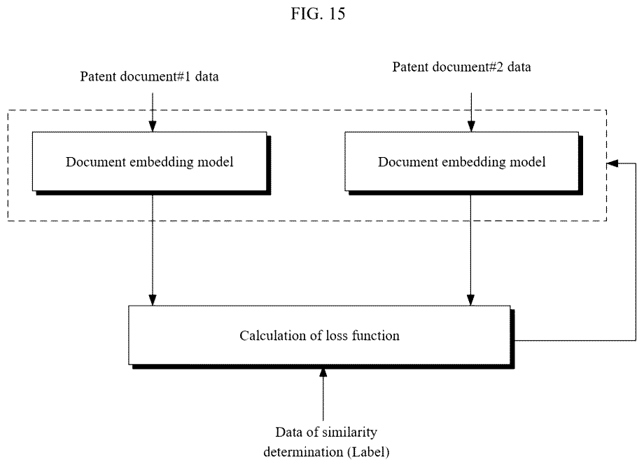

In order to utilize the document embedding model as shown in FIG. 14A, training is required for the neural network constituting the document embedding model. The document search method according to an embodiment of the present invention may be configured to perform the training using data on patent examination, trial, and/or judgment. The training of the document embedding model may be performed as shown in FIG. 15.

FIG. 14B is a drawing showing the structure of a sentence embedding model according to an embodiment of the present invention. FIG. 14B shows the structure of an artificial intelligence model that can be used to perform the sentence embedding generation 1114 of FIG. 13. Referring to FIG. 14B, the document embedding model includes a sentence transformer block 1131 and a sentence-by-sentence pooling block 1132.

The sentence transformer block 1131 receives primary embeddings 1130a including sentence embeddings and/or drawing embeddings as tokens, and generates embeddings for each comparison element using transformers of a hierarchical structure. Specifically, the sentence transformer block 1131 applies a sentence transformer and/or an image feature extractor to the input tokens for each comparison element, and applies a document transformer to the results, thereby generating secondary embeddings for each comparison element. In other words, the sentence transformer block 1131 tracks relationships between tokens included in the primary embeddings for each comparison element, and generates individual embeddings that are converted to express context and meaning.

In this case, although not shown in FIG. 14B, a block for generating the primary embeddings may exist, and the block for generating the primary embeddings may be implemented as an artificial intelligence model. For example, the block for generating the primary embeddings for sentences may extract sentences from a document as technical meaning units and generate embeddings corresponding to the extracted sentences. For example, the block for generating the primary embeddings for a drawing may be used to implement a multi modal structure, and may generate embeddings that express the shape, arrangement, etc. of the constitutive elements (e.g., features, letters, numbers, etc.) that constitute a patent drawing.

The sentence-by-sentence pooling block 1132 generates sentence embeddings 1130b by combining the secondary embeddings 1120b for each comparison element. Through this, the sentence embeddings 1130b of the document can be obtained so as to compare with the target invention.

The number of primary embeddings 1130a of FIG. 14B may be greater than the number of primary embeddings 1120a of FIG. 14A. The number of sentence transformers of FIG. 14B may be greater than the number of primary sentence transformers of FIG. 14A. That is, the document search method of the present invention may be configured to firstly quickly obtain a similar document list based on document embedding, and secondly additionally obtain information on similarity of similar documents based on sentence embedding.

FIG. 15 is a conceptual diagram showing the training process of a document embedding model according to an embodiment of the present invention. A sentence embedding model is also trained in substantially the same manner as the training process of the document embedding model described with reference to FIG. 15. However, a method of training the sentence embedding model uses labels for the similarity of sentences as learning data instead of patent documents, and uses sentence embedding instead of document embedding.

Referring to FIG. 15, two patent documents and labels for their similarity are used as learning data. First, document embeddings of each patent document are generated using the document embedding model, and the similarity is determined through comparison (e.g., distance calculation) of the document embeddings. By calculating a loss function based on the determined similarity and the similarity judgment data of the patent agency, i.e., the label, a loss value is derived. The derived loss value can be used for back-propagation operation for updating the document embedding model.

Herein, pairs of patent documents included in the learning data and the labels indicating their similarity may be generated from data related to examination, trial, and/or judgment of domestic and/or foreign patent agencies. For example, a notice of rejection issued from the Korean Intellectual Property Office, a trial decision issued from the Korean Patent Tribunal, and an invalidation decision issued from a U.S. court may be utilized. Since the documents of the relevant patent agencies include judgment on similarity or dissimilarity between patent documents of the patent agencies, the document search method may be configured to generate learning data from the relevant documents. Specifically, information including identification information of patent documents (e.g., application number, publication number, registration number, etc.), issuing agency, and similarity may be generated based on the documents issued by the patent agencies, and the learning data may be generated based on this information.

In an embodiment of FIG. 15, each of the document embedding models generates a document embedding representing the document corresponding to the input data, and the determination of similarity based on comparison between the embeddings is performed in a separate block. In this case, the label applied to each document embedding model may have the form of an embedding value. For example, if two documents are similar, the label is set to a median value of the two document embeddings, and the loss function can be calculated. As another example, if the two documents are dissimilar, the label is set to a value separated by a certain distance in a direction opposite to the direction facing each other in each of the two document embeddings, and the loss function can be calculated.

Contrary to this, if the document embedding model receives data of two patent documents and provides similarity as output data, the label may be information on similarity obtained through documents issued by the patent agency. For example, if the two patent documents are similar, the label is set to a probability value corresponding to similarity as the similarity of the two documents, and the loss function can be calculated. As another example, if the two documents are dissimilar, the label is set to a probability value corresponding to dissimilarity, and the loss function can be calculated.

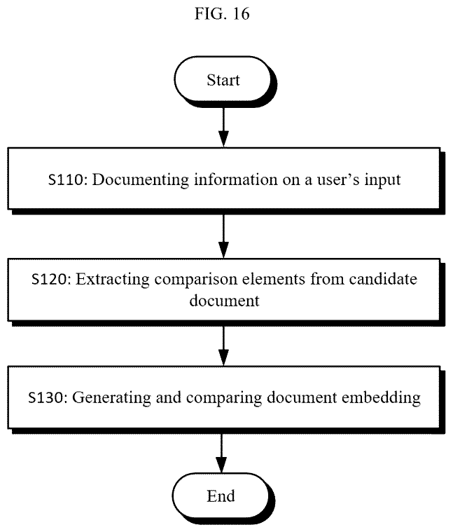

FIG. 16 is a flowchart for a comparison of input-based patent documents according to an embodiment of the present invention.

In operation S110, the document search method is configured to document information on a user's input. That is, the document search method is configured to document words and/or sentences, etc. input by the user to search for similar documents. Specifically, the document search method may be configured to document words and/or sentences, etc. by repeating/listing them according to a predetermined algorithm. Accordingly, comparison elements corresponding to information on the user's input may be generated.

In operation S120, the document search method is configured to extract the comparison elements from candidate documents. For example, the document search method may be configured to extract the comparison elements such as abstracts and claims, predetermined from patent documents.

In operation S130, the document search method is configured to generate and compare document embeddings. The document search method is configured to generate a first document embedding from the comparison elements of the target invention using the document embedding model as shown FIG. 14A, and generate a second document embedding from the comparison elements of the candidate document. Then, the document search method may be configured to determine whether there is similarity by calculating a distance between the first document embedding and the second document embedding and comparing the calculated distance with a threshold value. Herein, the distance between the first document embedding and the second document embedding may correspond to the primary similarity. For example, the larger the distance, the smaller the primary similarity may be treated.

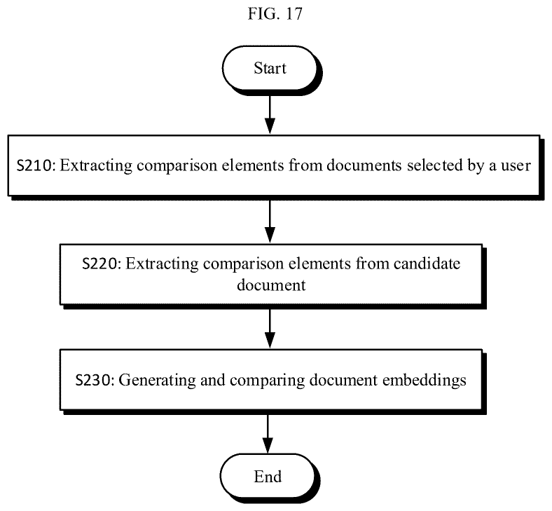

FIG. 17 is a flowchart for a comparison of document selection-based patent documents according to an embodiment of the present invention.

In operation S210, the document search method is configured to extract the comparison elements from the patent documents selected by the user. For example, the document search method may be configured to extract the comparison elements such as abstracts and claims that are predetermined from the patent documents. In this case, the invention described in the patent documents selected by the user becomes the target invention. That is, the document search method may be configured to generate the comparison elements of the target invention by extracting a portion of the selected patent documents as the comparison elements.

In operation S220, the document search method is configured to extract the comparison elements from the candidate documents. For example, the document search method may be configured to extract the comparison elements such as abstracts and claims that are predetermined from the patent documents.

In operation S230, the document search method is configured to generate and compare document embeddings. The document search method is configured to generate a first document embedding from the comparison elements of the selected patent documents using the document embedding model as shown in FIG. 14A, and generate a second document embedding from the comparison elements of the candidate documents. Then, the document search method may be configured to determine whether there is similarity by calculating a distance between the first document embedding and the second document embedding and comparing the calculated distance with a threshold value. Herein, the distance between the first document embedding and the second document embedding may correspond to the primary similarity. For example, the larger the distance, the smaller the primary similarity may be treated.

Through the operations as shown in FIGS. 16 and 17, the primary similarity between the target invention or the selected patent documents and the candidate documents may be determined. If these operations are repeatedly performed on a plurality of candidate documents, it may be determined whether the plurality of candidate documents is similar. The primary similarity is used to determine whether there are similar documents, and the secondary similarity, which is information on the similarity provided to the user, may be determined through another process. The secondary similarity may be provided together with information on similar documents, and furthermore, may be used to sort or filter the similar documents. That is, if the secondary similarity is additionally determined, it is possible to provide the user with a list of the similar documents together with information on the similarity of each similar document. The process of providing the information on the documents together with the information on the similarity is described in detail as follows.

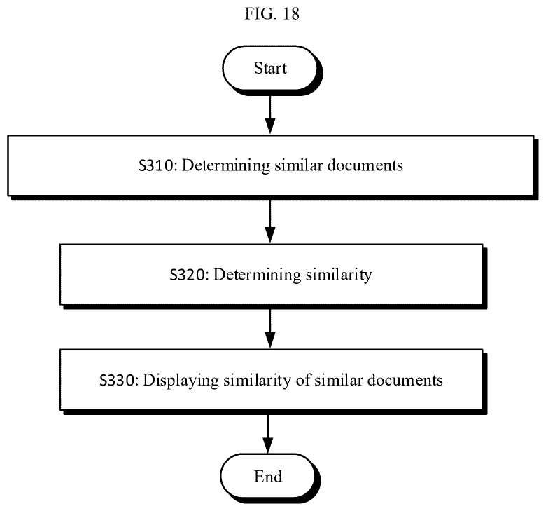

FIG. 18 is a flowchart for providing information on similar documents according to an embodiment of the present invention.

In operation S310, the document search method is configured to determine similar documents. The similar documents may be determined based on words and/or sentences input by the user or based on patent documents selected by the user. As a specific example, the similar documents may be determined using the primary similarity according to the procedure described with reference to FIG. 16 or FIG. 17.

In operation S320, the document search method is configured to determine similarity of the similar documents. In other words, the document search method may be configured to determine a secondary similarity of each of the similar documents based on words and/or sentences input by the user or based on the patent documents selected by the user. For example, the document search method may be configured to determine the secondary similarity of the similar documents by comparing sentences of the similar documents with words and/or sentences input by the user. As another example, the document search method may be configured to determine the secondary similarity of the similar documents by comparing sentences of the similar documents with at least one keyword of the patent documents selected by the user. Herein, the keyword is a word that has a large number of repetition in the patent documents selected by the user, and for example, may include at least one that appears above a threshold number or a threshold ratio.

In operation S330, the document search method is configured to display similarity of the similar documents. In addition, the document search method may be configured to further display information on the similar documents. That is, the document search method may be configured to display a list of the similar documents, and display a secondary similarity of each similar document together.

The secondary similarity may be determined and displayed as shown in FIG. 18. In this case, according to an embodiment of the present disclosure, the comparison of sentences and sentences and/or words or the comparison of sentences and at least one keyword may be performed using sentence embedding for the corresponding sentences, the corresponding words, or the corresponding keyword. The determination of the secondary similarity using the sentence embedding is described in detail as follows.

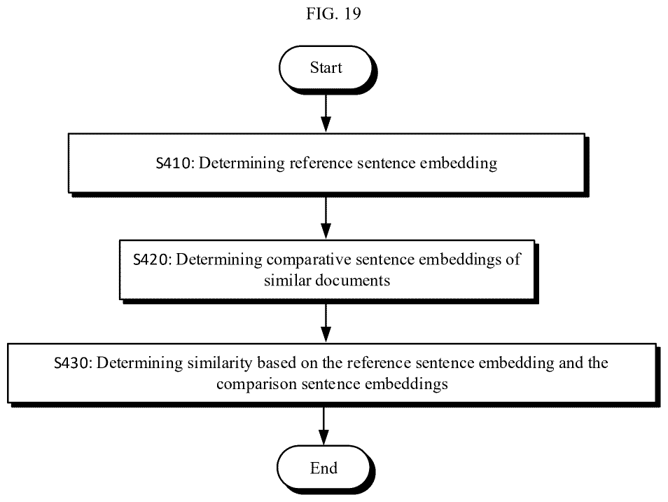

FIG. 19 is a flowchart for determining the similarity of similar documents according to an embodiment of the present invention. The secondary similarity for each similar document may be determined by repeating the operations described below for each similar document.

In operation S410, the document search method is configured to determine a reference sentence embedding. The reference sentence embedding may include a sentence embedding representing words and/or sentences input by the user, or a sentence embedding representing keywords of patent documents selected by the user. That is, the document search method may be configured to generate an embedding corresponding to a result of concatenating the input words and/or sentences into one sentence, or a result of concatenating at least one keyword.

In operation S420, the document search method is configured to determine comparative sentence embeddings of similar documents. The comparative sentence embeddings may include sentence embeddings for the sentences included in a range used for determination of a secondary similarity in the similar documents. Herein, the range used for determination of the secondary similarity may be the entirety or a portion of the patent documents. In case of a portion, the range used for determination of the secondary similarity may be the same as, partially the same as, or different from the range used for generating the document embedding.

In operation S430, the document search method is configured to determine the similarity based on the reference sentence embedding and the comparison sentence embeddings. According to an embodiment of the present invention, the document search method may be configured to calculate a distance between the reference sentence embedding and the comparison sentence embeddings, respectively, and determine the secondary similarity based on the comparison sentence embeddings having a distance less than or equal to a threshold value (for example, checking a ratio of the comparison sentence embeddings having a distance less than or equal to the threshold value). Alternatively, the document search method may be configured to calculate the distance between the reference sentence embedding and the comparison sentence embeddings, respectively, calculate an average of the distance values, and determine the secondary similarity based on the average value of the distances (for example, normalizing the reciprocal of the average value of the distances).

The present invention relates to a document search method for determining the similarity between a target invention and a candidate document, the method being performed by at least one processor. The document search method of the present invention may comprise the steps of: generating first comparison elements of the target invention, extracting second comparison elements from the candidate document, generating a first document embedding of the target invention and a second document embedding of the candidate document, based on the first comparison elements and the second comparison elements, and determining a primary similarity for determining whether the target invention and the candidate document are similar based on the first document embedding and the second document embedding.

The first document embedding and the second document embedding may be generated using a document embedding model.

The document embedding model may receive first embeddings including tokens generated from sentence-typed comparison elements and tokens generated from drawing-typed comparison elements, and may generate a document embedding representing the corresponding document.

The document embedding model may include a hierarchical transformer block which has a sentence transformer or an image feature extractor applied to the first embeddings, or a document transformer applied to the combination of outputs of the sentence transformer or the image feature extractor.

The document embedding model may further include a generating block which generates the document embedding by performing at least one polling operation on the output of the hierarchical transformer block in the document embedding model.

The document embedding model may be trained using learning data generated based on information on the similarity between patent documents and patent documents extracted from the documents issued by a patent agency.

A label of the learning data may include whether or not the patent documents are similar to each other as identified from the documents issued by the patent agency.

The label of the learning data may be set to a median value of the document embeddings of the two documents when the patent documents are identified to be similar from the documents issued by the patent agency.

The label of the learning data may be set to a value separated by a certain distance in a direction opposite to the direction facing each other in each of the document embeddings of the two documents when the patent documents are identified to be dissimilar from the documents issued by the patent agency.

The step of generating the first comparison elements may include a step of documenting at least one of words or sentences input by the user by repeating or listing them.

The document search method of the present invention may further comprise the steps of determining a secondary similarity between the target invention and the candidate document, and providing the secondary similarity to the user together with information on the candidate document.

The step of determining the secondary similarity may include the steps of determining a reference sentence embedding representing the target invention, determining comparison sentence embeddings corresponding to the sentences included in at least a portion of the candidate document, and determining the secondary similarity based on distances between the reference sentence embedding and the comparison sentence embeddings, respectively.

The present invention relates to a document search device for determining the similarity between a target invention and a candidate document. The document search device of the present invention may comprise a memory and a processor. The processor may control to generate first comparison elements of the target invention, extract second comparison elements from the candidate document, generate a first document embedding of the target invention and a second document embedding of the candidate document, based on the first comparison elements and the second comparison elements, and determine a primary similarity for determining whether the target invention and the candidate document are similar based on the first document embedding and the second document embedding.

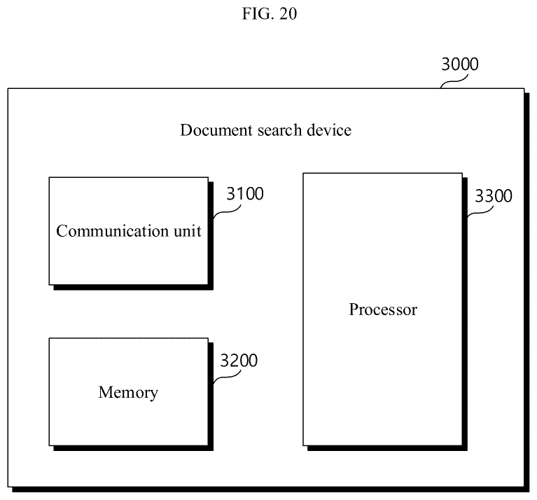

FIG. 20 is a block diagram showing the configuration of a document search device according to an embodiment of the present invention.

The document search device 3000 shown in FIG. 20 can perform the document search method described with reference to FIGS. 1 to 19. The document search device 3000 may include a communication unit 3100, a memory 3200, and a processor 3300. The document search device 3000 may be implemented as an embedded board, a smart phone, a tablet PC, a PC, a smart TV, a mobile phone, a personal digital assistant (PDA), a laptop, a vehicle, and other mobile or non-mobile computing devices, but is not limited thereto.

The communication unit 3100 may include one or more components that allow the document search device 3000 to communicate with an external electronic device. The communication unit 3100 may include a short-range wireless communication unit (not shown), a mobile communication unit (not shown), or a broadcast receiving unit (not shown). The short-range wireless communication unit may include a Bluetooth communication unit, a Bluetooth low energy (BLE) communication unit, a near field communication unit, a WLAN (Wi-Fi) communication unit, a Zigbee communication unit, an infrared (IrDA, infrared Data Association) communication unit, a WFD (Wi-Fi Direct) communication unit, a UWB (UltraWideband) communication unit, an Ant+ communication unit, etc., but is not limited thereto. The mobile communication unit transmits and receives a wireless signal with at least one of a base station, an external terminal, and a server on a mobile communication network. Herein, the wireless signal may include various types of data according to transmission and reception of a voice call signal, a video call signal, or text/multimedia message. The broadcast receiving unit receives a broadcast signal and/or broadcast-related information from the outside through a broadcast channel. The broadcast channel may include a satellite channel or a terrestrial channel. According to an embodiment, the communication unit 3100 may not include the broadcast receiving unit. The document search device 3000 may also receive order logs for existing items, attribute information for existing items, and attribute information for new items from an external device through the communication unit 3100.

The memory 3200 may store a program for processing and controlling the processor 3300, and may also store data input to or output from the document search device 3000. In addition, the memory 3200 may store information on candidate documents searched by the document search device 3000.

The memory 3200 may include at least one type of storage medium among a flash memory type, a hard disk type, a multimedia card micro type, a card type memory (for example, an SD or XD memory, etc.), a RAM (Random-Access Memory), a SRAM (Static Random-Access Memory), a ROM (Read-Only Memory), an EEPROM (Electrically Erasable Programmable Read-Only Memory), a PROM (Programmable Read-Only Memory), a magnetic memory, a magnetic disk, and an optical disk.

The processor 3300 may typically control overall operation of the document search device 3000. The processor 3300 may perform the document search method described with reference to FIGS. 13 to 19 by executing programs stored in the memory 3200. The processor 3300 may be implemented as a CPU (Central Processing Unit), and may also be implemented as a processing device such as a GPU (Graphic Processing Unit) and an NPU (Neural Processing Unit).

The above-described contents are concrete embodiments for carrying out the present invention. The present invention will include not only the embodiments described above, but also embodiments that may be simply designed and changed or be easily changed. In addition, the present invention will also include technologies that can be easily modified and implemented using the embodiments. Therefore, the scope of the present invention should not be limited to the embodiments described above, but should be determined by the claims described below as well as the equivalents of the claims of the present invention.

What is claimed is:

1. A document providing method that is performed by at least one processor and provides similar documents disclosing inventions similar to a target invention,
the method comprising the steps of:
searching for the similar documents based on at least one phrase input by a user;
listing the searched similar documents; and
listing cards from the searched similar documents, where the cards include at least one phrase or at least one similar phrase having a meaning similar to the at least one input phrase.

2. The document providing method according to claim 1, further comprising the steps of:
identifying that one of the similar documents is selected by the user; and
listing first cards including at least one of a first phrase or a first similar phrase having the meaning similar to the first phrase from the selected documents,
wherein the first phrase is a phrase corresponding to a first element among the at least one input phrase.

3. The document providing method according to claim 2, further comprising a step of listing second cards including at least one of a second phrase or a second similar phrase having the meaning similar to the second phrase from the selected documents,
wherein the second phrase is a phrase corresponding to a second element among the at least one input phrase.

4. The document providing method according to claim 3,
wherein a first card group including the first cards is arranged with a second card group including the second cards in a first direction,
each of the first cards is arranged in a second direction perpendicular to the first direction, and
each of the second cards is arranged in the second direction.

5. The document providing method according to claim 1, further comprising:
a first area generating step of displaying the 1^{st}-1 card of a first card group in a first area, and the 2^{nd}-1 card of a second card group in a second area; and
a second area generating step of displaying the 1^{st}-2 card of the first card group instead of the 1^{st}-1 card in the first area depending on a user's operation;
wherein the first card group is configured of cards including at least one of a first phrase or a first similar phrase having the meaning similar to the first phrase in the similar documents, and
the second card group is configured of cards including at least one of a second phrase or a second similar phrase having the meaning similar to the second phrase in the similar documents.

6. The document providing method according to claim 5, further comprising: a third area generating step of, if one of the similar documents is selected by the user, listing cards corresponding to the selected documents in a third area;
wherein the first area and the second area are arranged in a first direction, and
the first area and the third area are arranged in a second direction perpendicular to the first direction.

7. The document providing method according to claim 2, further comprising:
listing bibliographic information, drawings, claims and detailed description for the selected documents, a scope of extraction of the first cards from the selected documents, and at least two of the first cards.

8. The document providing method according to claim 1,
wherein the similar documents are arranged in the order of high similarity with the at least one input phrase.

9. The document providing method according to claim 1,
wherein the plurality of cards are arranged in the order of high similarity with the at least one phrase.

10. The document providing method according to claim 1, further comprising a step of generating a claim chart screen displaying at least one labeling card labeled among the cards.

11. The document providing method according to claim 10,
wherein the claim chart screen lists the at least one labeling card in a first direction by dividing the labeling cards by each document, and lists other labeling cards included in the same documents in a second direction perpendicular to the first direction.

12. The document providing method according to claim 1, further comprising a step of listing first cards including at least one of a first phrase or a first similar phrase having the meaning similar to the first phrase from a plurality of similar documents among the similar documents,
wherein the first phrase is a phrase corresponding to a first element among at least one input phrase.
